(19) United States
(12) Patent Application Publication
(10) Pub. No.: US 2013/0151090 A1
(43) Pub. Date: Jun. 13, 2013

(54) VEHICLE SPEED CONTROL SYSTEM AND CONTROL METHOD FOR THE SAME

(71) Applicants: Chang Kook Chae, Suwon-si (KR); Heungseok Lee, Seoul (KR); Sukil Oh, Suwon-si (KR); Wan Soo Oh, Yongin-si (KR); Jin Hyun Kim, Seoul (KR)

(72) Inventors: Chang Kook Chae, Suwon-si (KR); Heungseok Lee, Seoul (KR); Sukil Oh, Suwon-si (KR); Wan Soo Oh, Yongin-si (KR); Jin Hyun Kim, Seoul (KR)

(73) Assignee: Hyundai Motor Company, Seoul (KR)

(21) Appl. No.: 13/588,422

(22) Filed: Aug. 17, 2012

(30) Foreign Application Priority Data
Dec. 9, 2011 (KR) 10-2011-0132276

(51) Int. Cl. G06F 17/00; B60T 7/12; F02D 9/00; F16H 59/44

(52) U.S. Cl. 701/54

(57) ABSTRACT

A vehicle speed control system and method controls vehicle speed when a constant speed travel system for a vehicle operates. The system includes a detector that detects travel speed of the vehicle, a throttle valve opening/closing unit that opens/closes a throttle valve in the vehicle, a brake control unit that controls the operation of a brake in the vehicle, a transmission control unit that changes shift stages of a transmission in the vehicle, and a control unit that extracts the difference between a travel speed and a desired speed and controls the throttle valve opening/closing unit, the brake control unit, and the transmission control unit to gradually operate in accordance with the extracted speed difference value, when the travel speed received from the speed detector is larger than the desired speed set in the constant speed travel system.

### CROSS-REFERENCE TO RELATED APPLICATION

The present application claims priority of Korean Patent Application Number 10-2011-0132276 filed Dec. 9, 2011, the entire contents of which application is incorporated herein for all purposes by this reference.

### BACKGROUND OF INVENTION

1. Field of Invention

The present invention relates to a vehicle speed control system and a control method for the same, and more particularly, to a system for controlling vehicle speed when a vehicle travels at a constant speed, and a method thereof.

2. Description of Related Art

Vehicles are equipped with a constant speed travel system for providing convenience for a driver

When a driver sets desired vehicle speed, the vehicle constant speed travel system maintains the set vehicle speed by automatically adjusting the amount of opening of a throttle of an engine without operating the acceleration pedal.

However, when a vehicle enter a slope and the constant speed travel system is not operated, the driver controls a desired vehicle speed by operating the acceleration pedal or the brake, but when the constant speed travel system is operated, it is difficult to control the vehicle due to large load applied to a vehicle shaft and to maintain the set vehicle speed. In particular, when a vehicle enters a downward slope, such as a downhill, the braking force outputted to the vehicle shaft is not sufficient and the vehicle speed exceeds the set vehicle speed.

As a control system for overcoming the problems, a system that performs braking by controlling a transmission gear ratio of a transmission by calculating the slope value of the road surface, braking the vehicle with a brake after determining whether the brake is operated, and determining whether shifting is controlled, when the vehicle enters a slope has been disclosed.

However, since the system described above performs the control with the brake even though there is a slight change in vehicle speed, braking is performed at speed larger than the changed vehicle speed, and thus fine control is difficult and abnormal sense due to braking is generated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a vehicle speed control system having advantages of effectively reducing vehicle speed when a constant speed travel system of a vehicle is operated and the vehicle speed increases, and a method thereof.

Various aspects of the present invention provide for a vehicle speed control system that controls vehicle speed when a constant speed travel system for a vehicle operates, including a detector that detects travel speed of the vehicle, a throttle valve opening/closing unit that opens/closes a throttle valve in the vehicle, a brake control unit that controls the operation of a brake in the vehicle, a transmission control unit that changes shift stages of a transmission in the vehicle, and a control unit that extracts the difference between a travel speed and a desired speed and controls the throttle valve opening/closing unit, the brake control unit, and the transmission control unit to gradually operate in accordance with the extracted speed difference value, when the travel speed received from the speed detector is larger than the desired speed set in the constant speed travel system.

The control unit may set a throttle control start line and a throttle control stop line which each have a speed difference value in a predetermined range from the desired speed, may close the throttle valve by using the throttle valve opening/closing unit when the travel speed detected by the speed detector is larger than the throttle control start line, and may open the throttle valve by using the throttle valve opening/closing unit when the travel speed detected by the speed detector is smaller than the throttle valve stop line.

The control unit may set the throttle control start line and the throttle control stop line such that the desired speed is provided between the throttle control start line and the throttle control stop line.

The control unit may set the braking force control start line and the braking force control stop line which each have a speed difference value within a predetermined range from the desired speed, may operate the brake control unit when the travel speed detected by the speed detector is larger than the braking force control start line, and may stop the operation of the brake control unit when the travel speed detected by the speed detector is smaller than the braking force control stop line.

The control unit may set the braking force control start line and the braking force control stop line to have a speed value higher than the desired speed.

The control unit may set a shift down line having a speed difference value within a predetermined range from the desired speed, and may shift down the shift stage by operating the transmission control unit when the travel speed detected from the speed detector is larger than the shift down line.

The control unit may set the shift down line to have a speed value higher than the desired speed.

Various aspects of the present invention provide for a method of controlling vehicle speed using the vehicle speed control system including determining whether an increase in speed is implemented by operating an acceleration pedal, when the speed of the vehicle increases, determining whether a speed difference value between travel speed of the vehicle and desired speed is larger than a throttle control start line, when the increase in speed is not implemented by operating the acceleration pedal, controlling the throttle of the vehicle by closing the throttle valve opening/closing unit, when the vehicle speed difference value between the travel speed of the vehicle and the desire speed is larger than the throttle control start line, determining whether the speed difference value is larger than a braking force control start line, when the throttle control is performed, controlling braking force in the vehicle by operating the brake control unit, when the speed difference value is larger than the braking force control start line, determining whether speed reduction of the vehicle satisfies a downhill speed reduction pattern condition, when the braking force control is performed, and shifting down the shift stage of the transmission, when the downhill speed reduction pattern condition is satisfied.

The method may further include determining whether the speed difference value is larger than the throttle control stop line before determining whether the speed difference value is larger than the braking force control start line, when the throttle control is performed.

The method may further include determining whether the speed reduction of the vehicle is larger than the braking force control stop line before determining whether the speed reduction of the vehicle satisfies the downhill speed reduction pattern condition, when the braking force control is performed.

According to various aspects of the present invention, it is possible to improve vehicle speed control performance against a fine vehicle speed change.

According to various aspects of the present invention, it is possible to implement various braking control methods by applying braking control step by step to a vehicle speed change.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram schematically illustrating an exemplary vehicle speed control system according to the present invention.

FIG. 2 is a diagram schematically illustrating a control reference of the vehicle speed control system of FIG. 1.

FIG. 3 is a flowchart illustrating an exemplary vehicle speed control method according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

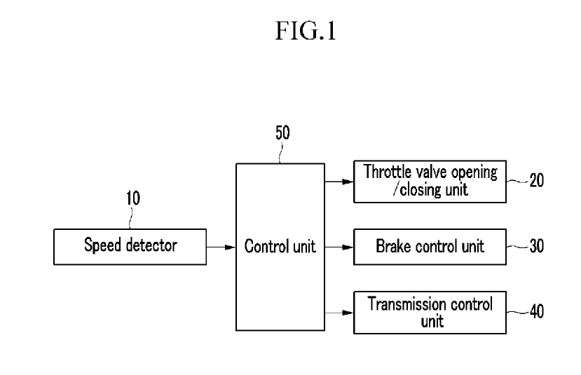

FIG. 1 is a diagram schematically illustrating a vehicle speed control system according to various embodiments of the present invention.

Referring to FIG. 1, a vehicle speed control system includes a speed detector 10, a throttle valve opening/closing unit 20, a brake control unit 30, a transmission control unit 40, and a control unit 50.

The speed detector 10 detects the travel speed of a vehicle and transmits the detected travel speed to the control unit 50.

The throttle valve opening/closing unit 20 adjusts inflow of air or a gas mixture by opening/closing the throttle valve in an engine. The throttle valve opening/closing unit 20 opens/closes the throttle valve, using an actuator receiving a control signal from the control unit 50. The speed of the vehicle is reduced by engine pumping load, by reducing the amount of air flowing into the engine.

The brake control unit 30 adjusts whether the vehicle is braked by adjusting the operation of the brake of the vehicle. The brake control unit 30 operates the brake in response to a control signal received from the control unit 50. According to an example, it is possible to adjust the braking force of the vehicle by adjusting pumping of the brake.

The transmission control unit 40 controls the travel speed of the vehicle by changing the shift stages of a transmission. When it is necessary to reduce the speed of the vehicle, the transmission control unit 40 shifts down a shift stage.

The control unit 50 controls the vehicle speed step by step in accordance with the travel speed detected by the speed detector 10. In the constant speed travel system, the vehicle travels in accordance with desired speed set by a user, and when the vehicle increases in speed by the inertia on a downhill, the control unit 50 controls the speed of the vehicle to be reduced in accordance with the difference between the actual travel speed and the desired speed.

In detail, the control unit 50 extracts the difference between the travel speed and the desired speed and controls the throttle valve opening/closing unit 20, the brake control unit 30, and the transmission control unit 40 to sequentially operate in accordance with the extracted speed difference value. That is, the control unit 50 transmits a control signal to the throttle valve opening/closing unit 20 to close the throttle valve and reduce the travel speed of the vehicle, when the speed difference value between the travel speed and the desired speed is beyond a predetermined range. When the speed difference value is beyond the predetermined range even if the vehicle is braked by closing the throttle valve, the control unit 50 operates the brake by transmitting a control signal to the brake control unit 30. Further, when the speed difference value is beyond the predetermined range or it is necessary to shift down the shift stages of the engine even if the vehicle is braked by operating the brake, the control unit 50 shifts down a shift stage of the transmission by transmitting a control signal to the transmission control unit 40.

In detail, the control reference of the vehicle speed control system may be described as follows.

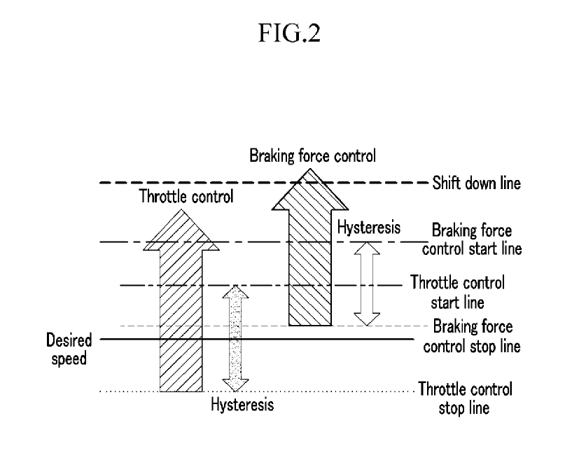

FIG. 2 is a diagram schematically illustrating a control reference of the vehicle speed control system of FIG. 1.

As shown in FIG. 2, the control unit 50 sets a throttle control start line and a throttle control stop line which each have a speed difference value in a predetermined range from the desired speed. That is, hysteresis of the throttle control is set. The throttle control start line is set higher than the desired speed by the speed difference value in a predetermined value and the throttle control stop line is set lower than the desired speed by the speed difference value in a predetermined range.

Therefore, the control unit 50 controls the throttle valve opening/closing unit 20 to be closed when the travel speed detected by the speed detector 10 is larger than the throttle control start line, and controls the throttle valve opening/closing unit 20 to be opened when the travel speed detected by the speed detector 10 is smaller than the throttle valve stop line. That is, the throttle control starts when the travel speed of the vehicle is larger than the throttle control start line and ends when the travel speed of the vehicle is smaller than the throttle control start line.

Further, the control unit 50 sets a braking force control start line and a braking force control stop line which each have a speed difference value in a predetermined range from the desired speed. That is, the hysteresis of the braking force control is set. The braking force control start line and the braking force control stop line are set to have a speed value higher than the desired speed.

Therefore, the control unit 50 operates the brake control unit 30 when the travel speed detected from the speed detector 10 is larger than the braking force control start line, and stops the operation of the brake control unit 30 when the travel speed detected by the speed detector 10 is smaller than the braking force stop line. That is, the braking force control starts when the travel speed of the vehicle is larger than the braking force start line and ends when the travel speed of the vehicle is smaller than the braking force stop line.

Further, the braking force control start line has a speed value higher than the throttle control start line and the braking force control stop line has a speed value lower than the throttle control start line. Therefore, a section where the braking force control and the throttle control are simultaneously implemented exists.

Further, the control unit 50 sets a shift-down line having a speed difference value in a predetermined range from the desired speed. The shift-down line is set to have a speed value higher than the desired speed.

Therefore, when the travel speed detected by the speed detector 10 is larger than the shift-down line, the control unit 50 operates the control unit 40 to shift down the shift stages.

Further, the shift-down reference may have a speed value higher than the braking force control start line. Therefore, the throttle control, the braking force control, and the shift control may be simultaneously implemented.

The vehicle speed control system having the configuration described above operates as follows.

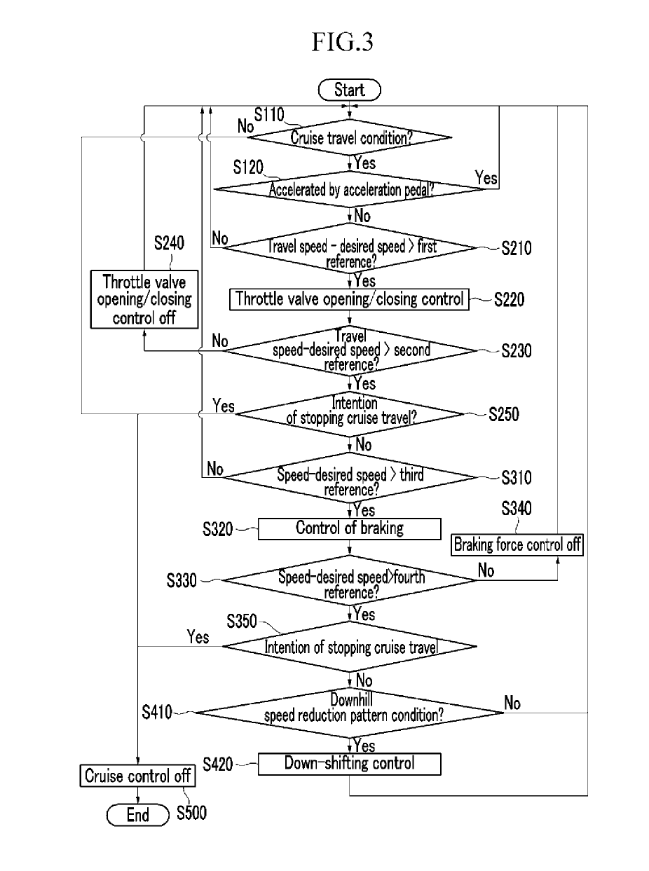

FIG. 3 is a flowchart illustrating a vehicle speed control method according to various embodiments of the present invention.

Referring to FIG. 3, when a vehicle is accelerated after the constant vehicle speed travel system, that is, a cruise travel system is operated, it is possible to reduce the travel speed of the vehicle by using the throttle valve opening/closing unit 20, the brake control unit 30, and the transmission control unit 40.

When cruise travel is implemented by a user and a desired speed is set, the vehicle travels at a constant speed in accordance with the desired speed. When the constant vehicle speed travel system keeps operating with the vehicle traveling, that is, when the cruise travel conditions are satisfied (S110), and when the vehicle is accelerated, the control unit 50 determines whether the vehicle is accelerated by the acceleration pedal or not (S120).

When the vehicle is accelerated by the acceleration pedal, it is determined whether the cruise travel conditions are satisfied, and when the conditions are not satisfied, the cruise control stops.

However, when the vehicle is accelerated not by the acceleration pedal, that is, when the speed of the vehicle is increased by the inertia on a downhill, the control unit 50 determines whether the speed difference between the travel speed and the desired speed is larger than a first reference (S210). The first reference means the throttle control start line.

The control unit 50 controls the throttle valve opening/closing unit 20 such that the throttle valve is closed when the speed difference value is larger than the first reference (S220) and allows the vehicle to travel in accordance with the constant vehicle speed travel system without braking the vehicle when the speed difference value is smaller than the first reference.

When the vehicle is braked by closing the throttle valve, it is determined whether the speed difference value is larger than a second reference (S230). The second reference means the throttle control stop line.

When the speed difference value is smaller than the second reference, the control unit 50 opens the throttle valve by stopping the control of the throttle valve opening/closing unit 20 (S240).

When the speed difference value is larger than the second reference, it is determined whether there is an intention of stopping the cruise travel (S250). The intention of stopping the cruise travel means that the user operates the brake or stops the constant vehicle speed travel system.

When there is an intention of stopping the cruise travel, the cruise travel is stopped, and when there is no intention of stopping the cruise travel, it is determined again whether the speed difference value is larger than a third reference (S310). The third reference means the braking force control start line. However, the intention of stopping the cruise travel may be implemented regardless of the braking flow of the vehicle speed control system.

When the speed difference value is larger than the third reference, the control unit 50 performs braking control with the brake by operating the brake control unit 30 (S320). When the speed difference value is smaller than the third reference, the control unit 50 determines again whether it is the cruise travel condition.

It is determined whether the speed difference value is larger than a fourth reference value after the braking force control of the vehicle (S330). The fourth reference means a shift down reference.

When the speed difference value is larger than the fourth reference, the control unit 50 determines whether there is an intention of stopping the cruise travel (S350). When the speed difference value is smaller than the fourth reference, the control unit 50 stops the braking force control by stopping the operation of the brake control unit 30.

When there is an intention of stopping the cruise travel, the cruise travel is stopped, and when there is no intention of stopping the cruise travel, whether it is a downhill speed reduction pattern condition is determined (S410). The downhill speed reduction pattern condition is determined by a control map about a shift stage set in advance in the control unit 50.

When the downhill speed reduction pattern condition is satisfied, the control unit 50 shifts down a shift stage of the transmission (S420). When down-shifting is controlled, the travel speed of the vehicle may rapidly decrease, and thus the operation of the vehicle speed control system stops and the vehicle travels at the desired speed of the constant speed traveling system.

The down-shifting control is not determined only by the speed difference value between the travel speed and the desired speed, such that the down-shifting control can be performed even if braking force control is not performed.

As described above, the vehicle speed control system reduces the travel speed of the vehicle step by step, and accordingly, the vehicle can travel in accordance with the desired speed of the constant speed travel system. Further, it is possible to control the speed of the vehicle by controlling the throttle even under a fine speed change, when the constant vehicle speed travel system operates.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A vehicle speed control system that controls vehicle speed when a constant speed travel system for a vehicle operates, comprising:
a detector that detects travel speed of the vehicle;
a throttle valve opening/closing unit that opens/closes a throttle valve in the vehicle;
a brake control unit that controls the operation of a brake in the vehicle;
a transmission control unit that changes shift stages of a transmission in the vehicle; and
a control unit that extracts the difference between a travel speed and a desired speed and controls the throttle valve opening/closing unit, the brake control unit, and the transmission control unit to gradually operate in accordance with the extracted speed difference value, when the travel speed received from the speed detector is larger than the desired speed set in the constant speed travel system.

2. The vehicle speed control system of claim 1, wherein the control unit:
sets a throttle control start line and a throttle control stop line which each have a speed difference value in a predetermined range from the desired speed;
closes the throttle valve by using the throttle valve opening/closing unit when the travel speed detected by the speed detector is larger than the throttle control start line; and
opens the throttle valve by using the throttle valve opening/closing unit when the travel speed detected by the speed detector is smaller than the throttle valve stop line.

3. The vehicle speed control system of claim 2, wherein the control unit:
sets the throttle control start line and the throttle control stop line such that the desired speed is provided between the throttle control start line and the throttle control stop line.

4. The vehicle speed control system of claim 1, wherein the control unit:
sets the braking force control start line and the braking force control stop line which each have a speed difference value within a predetermined range from the desired speed;
operates the brake control unit when the travel speed detected by the speed detector is larger than the braking force control start line; and
stops the operation of the brake control unit when the travel speed detected by the speed detector is smaller than the braking force control stop line.

5. The vehicle speed control system of claim 4, wherein the control unit:
sets the braking force control start line and the braking force control stop line to have a speed value higher than the desired speed.

6. The vehicle speed control system of claim 1, wherein the control unit:
sets a shift down line having a speed difference value within a predetermined range from the desired speed; and
shifts down the shift stage by operating the transmission control unit when the travel speed detected from the speed detector is larger than the shift down line.

7. The vehicle speed control system of claim 6, wherein the control unit:
sets the shift down line to have a speed value higher than the desired speed.

8. A method of controlling vehicle speed using the vehicle speed control system comprising:
determining whether an increase in speed is implemented by operating an acceleration pedal, when the speed of the vehicle increases;
determining whether a speed difference value between travel speed of the vehicle and desired speed is larger than a throttle control start line, when the increase in speed is not implemented by operating the acceleration pedal;
controlling the throttle of the vehicle by closing the throttle valve opening/closing unit, when the vehicle speed difference value between the travel speed of the vehicle and the desire speed is larger than the throttle control start line;
determining whether the speed difference value is larger than a braking force control start line, when the throttle control is performed;
controlling braking force in the vehicle by operating the brake control unit, when the speed difference value is larger than the braking force control start line;
determining whether speed reduction of the vehicle satisfies a downhill speed reduction pattern condition, when the braking force control is performed; and
shifting down the shift stage of the transmission, when the downhill speed reduction pattern condition is satisfied.

9. The method of claim 8, further comprising:
determining whether the speed difference value is larger than the throttle control stop line before determining whether the speed difference value is larger than the braking force control start line, when the throttle control is performed.

10. The method of claim 8, further comprising:
determining whether the speed reduction of the vehicle is larger than the braking force control stop line before determining whether the speed reduction of the vehicle satisfies the downhill speed reduction pattern condition, when the braking force control is performed.
